(19) United States
(12) Patent Application Publication
(10) Pub. No.: US 2009/0236319 A1
(43) Pub. Date: Sep. 24, 2009

(54) METHOD FOR JOINING OBJECTS

(76) Inventor: Christoph MATZ, Unterschleissheim (DE)

Correspondence Address: The BOC Group, Inc., 575 MOUNTAIN AVENUE, MURRAY HILL, NJ, 07974-2082, US

(21) Appl. No.: 12/235,973

(22) Filed: Sep. 23, 2008

(30) Foreign Application Priority Data
Sep. 28, 2007 (DE) 102007046709.7

(51) Int. Cl. B23K 35/38

(52) U.S. Cl. 219/74

(57) ABSTRACT

A method for joining at least two objects by a joining means selected from resistance welding, resistance soldering and a magnetically impelled arc, in which the objects are brought into contact with one another in the area to be joined, such that the objects are joined to one another in a particularly stable and/or particularly homogenous fashion and oxidation of the area to be joined is reliably prevented. The respective base metal of the objects is fused at least in the contact area, and in that at least one inert gas and/or at least an inert gas mixture is supplied at least to the contact area of the objects such that the fusing of the respective base metal takes place under an inert gas atmosphere.

### CROSS REFERENCE TO RELATED APPLICATIONS

The present application claims priority from German patent application DE 102007046709.7, filed Sep. 28, 2007.

### BACKGROUND OF THE INVENTION

The present invention pertains to a method for joining at least two objects by means of resistance welding or by means of resistance soldering or by means of a magnetically impelled arc (magnetic rotating arc) wherein the two objects are brought into contact with one another in the area to be joined so that the respective base metal of the objects is fused at least in the contact area and at least one inert gas or inert gas mixture is supplied to the contact area of the objects such that fusing of the respective base metal takes place under an inert gas atmosphere. In this case, an electric current is supplied to at least one of the objects and the electric current transfers from one object to the other object in the contact area; the contact area corresponds to the area of the transfer resistance that occurs during the transfer of the electric current.

Resistance joining is a pressure-joining method, in which the heat required for the joining process is generated by the resistance to an electric current flowing through the joining zone (with respect to resistance welding, for example, see DIN ISO 857-1). In this case, pressure is exerted at least in the contact area, wherein the objects are, in particular, pressed against one another in the contact area.

Depending on the material to be welded, different problems arise in resistance joining, i.e., in resistance welding or in resistance soldering or in hybrid forms of resistance welding and resistance soldering, as well as in joining (welding and/or soldering) by means of a magnetically impelled arc (magnetic rotating arc) under atmospheric conditions.

When joining unalloyed steel such as, for example, high-tensile steel, the area to be joined oxidizes during resistance joining under atmospheric conditions or during joining by means of a magnetically impelled arc under atmospheric conditions. This oxidation of the welding point or soldering point in connection with surface silicates complicates subsequent surface treatments such as, for example, washing, priming or painting of the area to be joined.

The main problem in this case is an inferior wetting of the surface of the oxidized joined area such that it becomes impossible to wash this area and paint layers applied on the joined area are uneven and rough, i.e., they have a so-called orange peel effect. In addition, the oxidation of the area to be joined influences the color of the paint such that the welding point stands out against the surface through several paint layers.

The welding point or soldering point also oxidizes when joining high-alloy or corrosion-resistant steel by means of resistance joining or by means of a magnetically impelled arc under atmospheric conditions. Furthermore, tempering colors form in the area around the welding point or soldering point such that the corrosion resistance of the material is lost.

In order to regain the corrosion resistance, it is necessary to carry out a complicated subsequent treatment with aggressive pickling agents. During this process, residues of the pickling acids may cause corrosion in the contact area of the objects or in the area of a gap between the joined components.

Resistance joining of aluminum is very difficult due to the high electric conductivity of aluminum. In order to achieve the desired ohmic resistance heating, it is necessary to operate with particularly high welding energies. Aluminum is also a very good thermal conductor such that the welding heat or the soldering heat dissipates far into surrounding areas.

This heat dissipation results in an increased oxide formation on the aluminum surface of the areas situated adjacent to the area to be joined because an oxide layer formed due to oxidation grows faster at elevated temperatures. This causes the oxide layer to become thick and brittle such that it loses its corrosion protection effect. In addition, an uneven oxide layer is disadvantageous with respect to surface treatments such as, for example, painting because color deviations may occur.

In the state of the art according to publication DE 22 46 559 A1, a pressure welding method is described, in which oxidation of the metal to be welded is prevented by enclosing the heated metal areas by or in an inert environment such as, for example, a nitrogen environment or an argon environment. In this method, the metal pieces to be connected are heated and pressed against one another with a force that suffices for achieving a forging of sorts.

In the state of the art according to publications DE 699 20 770 T2, JP 05131280 A and JP 10 20 23 73 A, a friction welding method with high-frequency heating is respectively described that is carried out under an inert gas atmosphere.

Consequently, methods known so far for resistance welding under an inert gas atmosphere are resistance welding, forge welding and pressure welding with high frequency. In these methods, friction, forging fire and skin effect are used at high-frequency currents in order to heat the joining areas to red heat. One common aspect of all these welding methods is that the melting temperature of the metal is not reached; the parts to be joined are rather mechanically pressed together in a pasty state.

### SUMMARY OF THE INVENTION

Based on the above-described disadvantages and deficiencies and with consideration of the outlined state of the art, the present invention aims to additionally develop a method of the initially cited type in such a way that the objects are joined to one another in a particularly stable and/or particularly homogenous fashion and oxidation of the area to be joined is reliably prevented.

This objective is attained with a method for joining at least two objects by means of resistance welding or by means of resistance soldering or by means of a magnetically impelled arc, wherein the objects are brought into contact with one another in the area to be joined characterized in that the respective base metal of the objects is fused at least in the contact area, and in that at least one inert gas and/or at least an inert gas mixture is supplied at least to the contact area of the objects such that the fusing of the respective base metal takes place under an inert gas atmosphere.

Advantageous embodiments and practical additional developments of the present invention are defined in the respective dependent claims.

The present invention therefore is based on carrying out

a resistance joining method or

a joining method with a magnetically impelled arc, in which the respective base metal of the objects is fused at least in the contact area, under an inert gas atmosphere, particularly under a controlled inert gas atmosphere, in order to prevent oxidation of the work piece surface or the fused base metal in the first place.

The resistance welding or the resistance soldering can be advantageously carried out in the form of

spot welding (see DIN ISO 857-1) or spot-wise resistance soldering or

projection welding (see DIN ISO 857-1) or

seam welding (see DIN ISO 857-1) methods; for example, resistance welding may be carried out by means of the resistance seam welding method described in Technical Bulletin DVS 2906-1 of June, 2006, which was published by DVS Publishing.

With respect to the process technology, the aforementioned methods differ significantly from friction welding methods according to the state of the art that are carried out under an inert gas atmosphere, namely because the base metal is respectively liquefied in spot welding, projection welding and seam welding, as well as in spot-wise resistance soldering, and solidified in a molten pool. A significantly improved joint can be achieved in this fashion.

The resistance joining methods proposed in accordance with one advantageous embodiment of the present invention [spot welding, spot-wise resistance soldering, projection welding and seam welding] also differ from friction welding methods according to the state of the art that are carried out under an inert gas atmosphere with respect to the heat generation and the intensity of the generated heat.

In spot welding, projection welding, seam welding and spot-wise resistance soldering, ohmic heating is realized due to the electrical resistance of the objects or work pieces and the transfer resistance between the objects. Consequently, the heat generation takes place in accordance with the active principle of ohmic resistance.

Furthermore, at least the contact area is heated above its melting temperature rather than pressing the objects together in a pasty state as it is the case in the state of the art. This means that at least one molten pool is formed of the molten base metal of the respective objects to be joined and this molten pool holds together the objects such as, for example, structural components or parts of a structural component after it cools.

The problems described earlier are significantly reduced or even eliminated with the inventive method. This can lead to potentially significant savings, in particular, because cleaning processes for removing oxides can be eliminated.

According to one particularly advantageous embodiment of the present invention, the inert gas or the inert gas mixture is selected in accordance with the respective base metals of the objects.

### DETAILED DESCRIPTION OF THE INVENTION

In order to join aluminum that may optionally be alloyed, for example, it is particularly advantageous to utilize an inert gas that features primarily argon, primarily helium or primarily an argon-helium mixture. In this case, the content of argon or helium or an argon-helium mixture may amount, in particular, to at least about 80 vol. %, for example, or about 95 vol. % to 100 vol. %.

In order to join steel, particularly low-alloy steel or unalloyed steel, it is particularly advantageous to utilize an inert gas that features

in its primary component argon (Ar), carbon dioxide (CO₂), helium (He) or nitrogen (N₂) and

as secondary component hydrogen (H₂) or oxygen (O₂) or that features at least a mixture of argon (Ar) and/or carbon dioxide (CO₂) and/or hydrogen (H₂) and/or helium (He) and/or nitrogen (N₂) and/or oxygen (O₂).

In order to join low-alloy steel or structural steel, it is advantageous to utilize an inert gas that has

a carbon dioxide (CO₂) content of about 10 vol. % to about 30 vol. %, for example about 18 vol. %, and

argon in the remaining volume.

Consequently, the inert gas or the inert gas mixture is advantageously selected in accordance with the materials to be joined, wherein the inert gas or the inert gas mixture may feature

in its primary component argon (Ar) and/or helium (He) in order to join aluminum and/or

pure argon (Ar), pure carbon dioxide (CO₂), pure hydrogen (H₂), pure helium (He), pure nitrogen (N₂), pure oxygen (O₂) or at least a mixture thereof in order to join steel or steels.

Alternatively or additionally, the inert gas or the inert gas mixture may have a carbon dioxide (CO₂) content of about 10 percent by volume (vol. %) to about 30 vol. %, particularly about 18 vol. %.

The inventive method is particularly advantageous for joining steel, especially high-alloy steel. In this case, the resistance welding may be carried out, for example, in the form of

the method for resistance spot welding steels up to an individual thickness of three millimeter described in Technical Bulletin DVS 2902-1 of September, 2001, as well as in Technical Bulletin DVS 2902-4 of October, 2001 and/or

the method for projection welding steels described in Technical Bulletin DVS 2905 of May, 2001, and/or

the method for resistance spot welding thin sheets of low-alloy steels or cold-rolled higher-strength steels described in Technical Bulletin DVS 2935-1 of September, 2004.

At least one of the objects advantageously may primarily feature at least in the area to be joined

aluminum, particularly high-alloy aluminum, low-alloy aluminum or non-alloyed aluminum and/or

low-alloy steel or non-alloyed steel and/or

coated steel, particularly coated steel sheet, and/or

high-strength steel.

The inventive method therefore can be advantageously utilized for joining

unalloyed steels, for example, also high-strength or coated steels,

stainless steels or high-alloy steels or

aluminum (alloys).

For example, the method according to the present invention may be carried out by means of the method for resistance spot welding and/or resistance seam welding aluminum and aluminum alloys with an individual thickness of about 0.35 millimeter to about 3.5 millimeter that is described in Technical Bulletin DVS 2932 (Part 3) of April, 1986.

According to one advantageous additional development of the present invention, objects or materials of respectively different types of base metals can also be joined to one another. For example, unalloyed steel can be joined to high-alloy steel or aluminum (alloy) can be joined to steel (alloy).

Furthermore, coated steel sheets can be advantageously joined to one another by means of the present invention.

The present invention is also particularly advantageous for joining objects of different thicknesses.

The present invention ultimately pertains to the utilization of at least one inert gas and/or at least one inert gas mixture in a method of the above-described type.

What I claim is:

1. A method for joining at least two objects wherein said method for joining is selected from the group of resistance welding, resistance soldering, and a magnetically impelled arc, wherein the objects are brought into contact with one another in the area to be joined, characterized in that the respective base metal of the objects is fused at least in the contact area, and in that at least one inert gas or at least an inert gas mixture is supplied to the contact area of the objects such that the fusing of the respective base metal takes place under an inert gas atmosphere.

2. The method according to claim 1, characterized in that the resistance welding or the resistance soldering is carried out by means selected from the group consisting of spot welding, spot-wise resistance soldering, projection welding and seam welding.

3. The method according to claim 1, characterized in that the base metal of at least one of the objects consists of primarily aluminum, primarily of steel, primarily of coated steel, and primarily of high-strength steel, in the area to be joined.

4. The method according to claim 1, characterized in that the aluminum is selected from the group consisting of high-alloy aluminum, low-alloy aluminum and non-alloyed aluminum.

5. The method according to claim 1, characterized in that the steel is selected from the group consisting of high-alloy steel, low-alloy steel and non-alloyed steel.

6. The method according to claim 1, characterized in that the coated steel is coated steel sheet.

7. The method according to claim 1, characterized in that the inert gas or the inert gas mixture is selected in dependence on the base metal in the area to be joined of at least one of the objects.

8. The method according to claim 7, characterized in that when the base metal is aluminum, the inert gas or inert gas mixture is selected from the group consisting of argon, helium and mixtures thereof.

9. The method according to claim 8, characterized in that the inert gas or inert gas mixture is present in an amount of about 80 vol. % to about 100 vol. %.

10. The method according to claim 8, characterized in that when the base metal is selected from the group consisting of steel, low-alloy steel and non-alloyed steel, the inert gas or inert gas mixture is selected from the group consisting of argon, carbon dioxide, hydrogen, helium, nitrogen, oxygen and mixtures thereof.

11. The method according to claim 10, characterized in that the inert gas or the inert gas mixture has a carbon dioxide content of about 10 vol. % to about 30 vol. % in order to join low-alloy steel or structural steel.

12. The method according to claim 11, characterized in that the inert gas or the inert gas mixture has a carbon dioxide content of about 18 vol. % in order to join low-alloy steel or structural steel.

13. The method according to claim 11, characterized in that argon is present in the inert gas mixture.

14. The method according to claim 1, characterized in that the objects are selected from groups of objects having different thicknesses.

15. The method according to claim 1, characterized in that the objects consist of different types of base metals in the areas to be joined.

16. The method according to claim 15, characterized in that the different types of base metals are selected from the group consisting of unalloyed steel, high-alloy steel, aluminum and steel.
